(19) United States
(12) Patent Application Publication
(10) Pub. No.: US 2026/0143000 A1
(43) Pub. Date: May 21, 2026

(54) PROBABILISTIC ATTACK TECHNIQUE DETECTION IN EXTENDED DETECTION AND RESPONSE SYSTEMS

(71) Applicant: Cisco Technology, Inc., San Jose, CA (US)

(72) Inventors: Matthew Scott Robertson, Ontario (CA); Sunil Navinchandra Amin, Atlanta, GA (US); Carlos E. Caballero, Suwanee, GA (US)

(21) Appl. No.: 18/951,156

(22) Filed: Nov. 18, 2024

(51) Int. Cl. H04L 9/40

(52) U.S. Cl. CPC H04L 63/1441; H04L 63/1416

(57) ABSTRACT

This disclosure describes techniques for determining an attack technique by monitoring data from devices in a computer network. The method includes receiving monitoring log sets from monitoring systems, determining patterns and weighted probabilities of an attack technique based on the log sets and reliability weights associated with each monitoring system, determining a probability of the attack technique occurring in relation to a device attribute, and determining that the network is affected by the attack technique based on the determined probabilities. The method further includes performing a responsive action based on the determined data.

### TECHNICAL FIELD

The present disclosure relates generally to the field of network security monitoring. More particularly, the disclosure relates to systems and methods for more accurately labeling attack techniques associated with detected attacks and/or attack chains in an Extended Detection and Response (XDR) system.

### BACKGROUND

In the field of network security, detection and response systems play a critical role in identifying and mitigating threats to an organization's networks and devices. Traditional security solutions often operate in silos, focusing on specific areas such as the network perimeter, endpoints, and/or cloud environments. However, as the threat landscape evolves and attacks become more sophisticated, there is a growing need for a holistic approach to security monitoring and incident response. Extended Detection and Response (XDR) systems aim to address this need by providing a unified platform that collects, correlates, and analyzes monitoring logs (e.g., telemetry data) from multiple monitoring systems.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts an example environment with an Extended Detection and Response (XDR) system that interacts with a set of monitoring systems.

FIG. 2 is a data flowchart datagram of an example process for determining an extended attack technique detection with a list of potential attack techniques.

FIG. 3 is a data flowchart diagram of an example process for determining an enhanced attack technique detection with a set of likely attack techniques selected from a list of potential attack techniques.

FIG. 4 provides an operational example of determining a posterior attack technique probability associated with an attack technique based on attack patterns represented by one or more monitoring log set(s).

FIG. 5 is a flowchart diagram of an example process for responding to computer network attacks based on attack technique probabilities.

FIG. 6 is a flowchart diagram of an example process for determining an attack technique based on monitoring log sets associated with two or more times.

FIG. 7 is a flowchart diagram of an example process for determining an attack technique probability based on monitoring log sets, attack patterns, reliability weights, and/or device profiles.

FIG. 8 is a flowchart diagram of an example process for responding to an attack associated with an attack technique.

FIG. 9 shows an example computer architecture for a server computer capable of executing program components for implementing the functionality described above.

### DESCRIPTION OF EXAMPLE EMBODIMENTS

### Overview

Aspects of the invention are set out in the independent claims and preferred features are set out in the dependent claims. Features of one aspect may be applied to each aspect alone or in combination with other features.

This disclosure provides techniques for determining an attack technique based on monitoring data associated with one or more devices in a computer network. In some cases, the techniques described herein relate to a method including receiving, by a processor, a plurality of monitoring log sets from a plurality of monitoring systems, the plurality of monitoring systems being configured to monitor a computer network. The method may further include determining, by the processor, a first pattern based on a first monitoring log set of the plurality of monitoring log sets, the first monitoring log set received from a first monitoring system of the plurality of monitoring systems. The method may further include determining, by the processor, a second pattern based on a second monitoring log set of the plurality of monitoring log sets, the second monitoring log set received from a second monitoring system of the plurality of monitoring systems. The method may further include determining, by the processor, a first weighted probability of occurrence of an attack technique based on the first pattern and a first reliability weight, the first reliability weight being associated with the first monitoring system. The method may further include determining, by the processor, a second weighted probability of occurrence of the attack technique based on the second pattern and a second reliability weight, the second reliability weight being associated with the second monitoring system. The method may further include determining, by the processor, a first probability based on the first weighted probability and the second weighted probability, the first probability being associated with the plurality of monitoring log sets and the attack technique. The method may further include determining, by the processor, a second probability of occurrence of the attack technique in relation to a first device attribute associated with the computer network. The method may further include determining, by the processor and based on the first probability and the second probability, first data representing that the computer network is affected by the attack technique. The method may further include performing, by the processor, a responsive action based on the first data.

### EXAMPLE EMBODIMENTS

This disclosure provides techniques for determining an attack technique based on monitoring data associated with one or more devices in a computer network. These techniques may, for example, be used for attack technique determination in an Extended Detection and Response (XDR) system. Such a determination may be used to perform a responsive action in relation to the one or more devices and/or the computer network. The responsive action may include initiating an automated remedial action, providing an alert to a user (e.g., to a security analyst using the XDR system), blocking access by a device that is determined be affected by an attack technique to a computer network and/or to a network device (e.g., a network device associated with a network service), monitoring network traffic associated with the affected device, and/or quarantining the affected device. The techniques disclosed herein may, for example, include using one or more probabilistic models, one or more decision-tree-based models, and/or one or more heuristic-based models to determine an attack technique associated with one or more device(s) in a computer network.

In some cases, an example system may be configured to: (i) receive one or more monitoring log sets each from one of one or more monitoring systems, (ii) identify an attack technique, (iii) identify one or more affected devices associated with one or more device profiles, (iv) determine one or more attack patterns based on the one or more monitoring log sets, (v) determine a first probability (e.g., a conditional probability) of the occurrence of the attack technique given the one or more attack patterns, (vi) determine a second probability (e.g., a conditional probability) of the occurrence of the attack technique given the one or more affected device profiles, (v) determine a third probability (e.g., a marginal probability) of observing the one or more attack patterns and/or of involvement of the one or more device profiles, (vi) determine one or more reliability weights each associated with one of the one or more attack patterns, and/or (vii) determine whether the one or more monitoring log sets are associated with the attack technique based on the first probability, the second probability, the third probability, and/or the reliability weight(s).

In some cases, the techniques described herein include using a probabilistic model to determine an attack technique based on monitoring log(s) associated with a computer network and/or device profile(s) associated with device(s) in a computer network. The probabilistic model may, for example, be a Bayesian probability model. Such a Bayesian probability model may, for example, compute a posterior probability (P(t|M), P(t|D), and/or P(t|M, D)) of an attack technique (t) given |M| attack patterns (M) represented by the monitoring log(s) and/or |D| device profiles (D). This posterior probability may, for example, be determined based on one or more of the following: (i) |M| “technique-specific pattern probabilities” (P(Mᵢ|t) for i=1, . . . , |M|) each representing a probability of observing an ith attack pattern (Mᵢ) given the attack technique (t), (ii) |M| “reliability weights” (Wᵢ for i=1, . . . , |M|) each representing a confidence in accurate detection of an ith attack pattern (Mᵢ), (iii) |D| “technique-specific device probabilities” (P(Dⱼ|t) for j=1, . . . , |D|) each representing a probability of a jth device profile (Dᵢ) given the attack technique (t), (iv) a “technique probability” (P(t)) representing a probability of the attack technique (t) (e.g., prior to observing the |M| attack patterns (M) and/or determining involvement of the |D| device profiles), or (v) a “marginal probability” (P(M₁, . . . , M_{|M|}), P(D₁, . . . , D_{|D|}), and/or P(M₁, . . . , M_{|M|}, D₁, . . . , D_{|D|})) representing a probability of observing the |M| attack patterns ({Mᵢ}) for i=1, . . . , |M|), and/or of involvement of the |D| device profiles ({Dⱼ} for j=1, . . . , |D|)).

For example, in some cases, the system may determine P(t|M) based on the operations associated with the following equation:

$$P ( t \vert M , D ) = \frac{{\prod }_{i = 1}^{\vert M \vert} {P ( {M}_{i} \vert t )}^{{w}_{i}} * {\prod }_{j = 1}^{\vert D \vert} P ( {D}_{j} \vert t )}{P ( {M}_{1} , … , {M}_{\vert M \vert} , {D}_{1} , … , {D}_{\vert D \vert} )} . \qquad ( Equation 1 )$$

As another example, in some cases, the system may determine P(t|M) based on the operations associated with the following equation:

$$P ( t \vert M ) = \frac{{\prod }_{i = 1}^{\vert M \vert} {P ( {M}_{i} \vert t )}^{{w}_{i}}}{P ( {M}_{1} , … , {M}_{\vert M \vert} )} . \qquad ( Equation 2 )$$

As another example, in some cases, the system may determine P(t|M) based on the operations associated with the following equation:

$$P ( t \vert M ) = \frac{{\prod }_{i = 1}^{\vert M \vert} P ( M \vert t )}{P ( {M}_{1} , … , {M}_{\vert M \vert} )} . \qquad ( Equation 3 )$$

As another example, in some cases, the system may determine P(t|M) based on the operations associated with the following equation:

$$P ( t \vert D ) = \frac{{\prod }_{j = 1}^{\vert D \vert} P ( {D}_{j} \vert t )}{P ( {D}_{1} , … , {D}_{\vert D \vert} )} . \qquad ( Equation 4 )$$

In some cases, in Equations 1-4: (i) |M| represents a number of attack patterns (e.g., determined based on a set of monitoring log sets), (ii) i is an index variable that iterates over the |M| attack patterns, (iii) each P(Mᵢ|t) represents a probability of observing the ith attack pattern given the attack technique t, (iv) each Wᵢ is a reliability weight associated with the ith attack pattern, (v) each P(Mᵢ) represents a probability (e.g., a prior probability) of observing the ith attack pattern, (vi) |D| represents a number of devices profiles (e.g., each associated with one of |D| devices, such as |D| affected devices), (vii) j is an index variable that iterates over the |D| device profiles, and/or (viii) each P(t|Dⱼ) represents a probability of the attack technique (t) given the jth device profile (e.g., associated with the jth affected device of |D| affected devices).

In some cases, P(M₁, . . . , M_{|M|}, D₁, . . . , D_{|D|}) is determined based on the equation:

$$( Equation 5 )$$

$$P ( {M}_{1} , … , {M}_{\vert M \vert} , {D}_{1} , … , {D}_{\vert D \vert} ) = {\sum }_{k = 1}^{\vert t \vert} {\prod }_{i = 1}^{\vert M \vert} {P ( {M}_{i} \vert t )}^{{w}_{i}} * {\prod }_{j = 1}^{\vert D \vert} P ( {D}_{j} \vert t ) .$$

In some cases, P(M₁, . . . , M|_{M}|) is determined based on the equation:

$$P ( {M}_{1} , … , {M}_{\vert M \vert} ) = {\sum }_{k = 1}^{\vert t \vert} {\prod }_{i = 1}^{\vert M \vert} {P ( {M}_{i} \vert t )}^{{w}_{i}} . \qquad ( Equation 6 )$$

In some cases, P(D₁, . . . , D_{|D|})) is determined based on the equation:

$$P ( {D}_{1} , … , {D}_{\vert D \vert} ) = {\sum }_{k = 1}^{\vert t \vert} {\prod }_{j = 1}^{\vert D \vert} P ( {D}_{j} \vert t ) . \qquad ( Equation 7 )$$

In Equations 5-7, k may iterate over |t| potential attack techniques.

Monitoring log(s) may represent one or more types of information collected by monitoring system(s) deployed in a computer network and/or in one or more devices in a network. This information may include, but is not limited to, network traffic data, system log(s), application log(s), security alert(s), and/or user activity record(s). The monitoring log(s) may be used to identify pattern(s), anomal(ies), and/or indicator(s) of compromise that represent the presence and/or absence of an attack technique. In some cases, monitoring log(s) may represent one or more attack patterns. An attack pattern may represent one or more Indicators of Compromise (IoCs) and/or one or more Indicators of Attack (IoAs). An IoC may represent an artifact observed on a network and/or in an operating system that represents a computer intrusion. An IoA may represent an artifact observed on a network and/or in an operating system that represents an intrusion attempt. Examples of IoCs and/or IoAs may include unusual network traffic pattern(s), unusual user account activity pattern(s), unusual user geographical location pattern(s), malware pattern(s), web compromise pattern(s), and/or domain name system change(s).

Monitoring log(s) may be generated by one or more monitoring systems. A monitoring system may include a computing (e.g., software and/or hardware) component that collects, processes, and/or reports data related to various aspects of a computer network's activity and/or security state. A monitoring system may be designed to detect and/or alert on potential security threat(s), anomal (ies), and/or policy violation(s). Examples of monitoring systems include intrusion detection systems (IDSs), intrusion protection systems (IPSs), security information and event management (SIEM) systems, endpoint detection and response (EDR) systems, user and entity behavior analytics (UEBA) systems, firewalls, and security protection systems.

An attack pattern may be associated with a respective attack technique and/or may represent one or more events and/or one or more indicators. In some cases, if the monitoring log(s) set(s) associated with a period includes the event(s) and/or indicator(s) represented by the attack pattern, the system may determine that an attack associated with the respective attack technique likely occurs and/or likely does not occur in the period. Examples of an attack patterns include attack pattern(s) associated with detecting a threshold number of sequential failed login attempt followed by a successful login from an unusual location, detecting a threshold number of suspicious procession injections within a defined period, and/or detecting a threshold number of unauthorized data exfiltration attempts within a defined period. For example, if a brute-force login attack technique is associated with an attack pattern related to detecting a threshold number of sequential failed login attempt followed by a successful login from an unusual location, then the system may determine that a brute-force login attack is likely within a period if the monitoring log(s) set(s) associated with that period represent a detection of a threshold number of sequential failed login attempt followed by a successful login from an unusual location.

In some cases, an attack pattern represents that monitoring log(s) associated with a period satisfy a heuristic associated with an attack technique. A heuristic may be a rule that, when satisfied by a monitoring log(s) set associated with a period, represents that occurrence of an attack associated with the attack technique is likely or unlikely within the period. For example, a heuristic associated with a brute-force login attack technique: (i) may be satisfied if the number of failed login attempts from a single Internet Protocol (IP) address exceeds a threshold, and (ii) may represent that a brute-force login attack is likely. In this example, if the monitoring log(s) associated with a period indicates a threshold-exceeding number of failed login attempts from a single IP address, the system may determine that the period is likely associated with a brute-force login attack.

An attack pattern may be associated with a reliability weight. The reliability weight associated with an attack pattern may represent: (i) a degree of confidence in accurate detection of the attack pattern, (ii) a degree of confidence in accuracy of the monitoring log(s) used to determine presence of the attack pattern, and/or (iii) a degree of reliability of a monitoring system whose generated data is used to determine the attack pattern. For example, if the monitoring system is determined to have a high error rate in reporting data related to an attack pattern, the reliability weight assigned to the pattern may be lower. As another example, if an attack pattern is determined based on data known to be frequently noisy (e.g., geolocation data), the reliability weight associated with the pattern may be lower. As another example, if an attack pattern is determined to be based on data that can be spoofed, the reliability weight associated with the pattern may be lower. Example techniques for determining reliability weight(s) associated with attack pattern(s) are described in greater detail below.

A device profile may represent one or more identifiers, types, characteristics, behaviors, configurations, and/or vulnerabilities of a device in a computer network. For example, a device profile may indicate that a device is a Kerberos server. In some cases, a device profile may be determined based on a historical behavior of a device. For example, the system may determine, based on historical data associated with a device, that the device is a Kerberos server, for example based on determining that the Kerberos server responds to authentication requests and/or issues service tickets for users and services within the network with a threshold frequency. Such behavior(s) may be detected based on logs that capture the frequency and/or type of requests the device handles, the protocols used by the device in handling such requests, and/or the like. In some cases, determining a device profile associated with a device includes: (i) determining that a device is affected by an event associated with the one or more monitoring log sets (e.g., received from one or more monitoring systems), and/or (ii) determining the device profile associated with that affected device. Example techniques for mapping monitoring log(s) to affected device(s) and/or to device profile(s) are described in greater detail below.

A technique-specific pattern probability (P(Mᵢ|t)) may represent a probability of observing an attack pattern given occurrence of the attack technique. For example, given an attack pattern M₁ associated with detecting a defined number of sequential login attempt failures followed by a successful login attempt within a threshold period and an attack pattern M₂ associated with detecting a single login failure, and given an attack technique related to brute-force login attack, P(M₁|t) may be higher than P(M₂|t). This may be because the former pattern is more indicative of a brute-force login attack, while the latter may be caused by a legitimate user's typing error and/or forgotten password.

In some cases, to determine the technique-specific probability of an attack pattern given an attack technique, the system uses historical data, expert input(s), and/or machine learning technique(s). For example, historical data may represent previously observed instances of the attack technique and/or the corresponding attack pattern(s) detected during those instances. By performing statistical analysis on such historical data, the system can estimate the likelihood of observing a specific attack pattern when the attack technique is known to have occurred. For example, suppose the system has a dataset of 100 confirmed instances of a particular attack technique. If an attack pattern M₁ was observed in 80 of those instances, the system may estimate the technique-specific probability P(M₁|t) as 0.8 (80/100). Similarly, if an attack pattern M₂ was observed in only 30 of those instances, the system may estimate P(M₂|t) as 0.3 (30/100). In some cases, the sum of |M| reliability weights for |M| attack patterns associated with attack technique may always equal a particular number (e.g., one), for example to enable the summations of the |M| technique-specific probabilities associated with the same attack technique to fall within a range (e.g., a range of zero to one).

A technique probability (P(t)) may represent a probability of observing an attack technique (t) prior to and/or independent of observing the monitoring log(s) set(s). For example, a technique probability associated with a brute-force login attack may represent the general likelihood of encountering a brute-force login attack in a computer network, without reference to any specific monitoring log(s) or attack patterns. In some cases, P(t) may serve as a prior probability of the attack technique in the probabilistic model.

In some cases, to determine the technique probability associated with an attack technique, the system may use historical data representing how frequently the attack technique has been observed in the past across one or more computer networks. For example, if historical data represents that, out of 1000 time periods (e.g., randomly selected time periods) across a set of networks, a Structured Query Language (SQL) injection attack was detected in 20 of those periods, the system may then determine the technique probability for SQL injection attacks as 0.02. In some cases, the system may determine the technique probability based on expert knowledge and/or machine learning model(s) trained on historical data. For example, security analyst(s) may provide input on the expected prevalence and/or expected likelihood of different types of attack techniques based on their experience, which the system may use to set and/or adjust the technique probability values.

A technique-specific device probability (P(t|Dⱼ)) may represent a probability that a particular device, a particular device attribute (e.g., device type), and/or a particular device profile may be affected by, targeted by, and/or vulnerable to an attack technique. For example, if a device is known to be running an outdated operating system with one or more unpatched vulnerabilities, this device may have a higher technique-specific device probability for one or more attack techniques that exploit those vulnerabilities compared to a device without those vulnerabilities. In some cases, to determine a technique-specific device probability associated with an attack technique and a device profile, the system may use historical data representing how frequently do device(s) having the device profile are affected by the attack technique. For example, if historical data shows that devices running a particular version of a web server software were compromised by a remote code execution attack in 80% of observed cases, the system might assign a technique-specific device probability of 0.8 for the remote code execution attack technique with respect to the category of devices that run the particular version of the web server software.

In some cases, if more than one device are affected by an attack technique, the technique-specific device probability (P(t|Dⱼ)) may be determined based on combining |D| P(t|Dⱼ), each representing a probability of occurrence of the attack technique given a device profile of a jth affected device. For example, P(t|D) may be determined based on a product of the |D|P(t|Dⱼ) values, an average of the |D|P(t|Dⱼ) values, and/or a maximum of the |D|P(t|Dⱼ) values. For example, consider a network consisting of 100 devices, where 20 devices are running an outdated operating system with known vulnerabilities, and the remaining 80 devices are running an updated operating system. Historical data may represent that those devices running the outdated operating system have a 90% probability of being affected by a specific ransomware attack technique (i.e., P(t|D₁)=0.9), while devices running the updated operating system have a 10% probability of being affected (i.e., P(t|D₂)=0.1). To determine the overall technique-specific device probability (P(t|D)), the system may compute the average of the individual probabilities: P(t|D)=(0.9×20+0.1×80)/100=0.26. This may represent that there is a 26% probability of a device in the network being affected by the ransomware attack technique.

In some cases, the system uses one or more probabilities described above to determine whether monitoring log(s) associated with an environment and a particular period indicate occurrence of an attack technique. For example, consider a scenario in which the system receives a request to determine whether monitoring log(s) associated with an environment represent a Kerberoasting technique (t₁) or a data exfiltration technique (t₂). The system may determine the following three attack patterns: (i) suspicious authentication requests (M₁) with a reliability weight of W₁=1, (ii) failed authentication attempts with (M₂) with a reliability weight of W₂=0.8, and (iii) an abnormal data transfer (M₃) with a reliability weight of W₃=1.2. The system may determine that two device profiles are associated with the device(s) involved in the detected monitoring log(s): a proxy server profile (D₁) and a Kerberos server profile (D₂).

In this example, the system may determine the following technique probabilities: P(t₁)=0.3 and P(t₂)=0.7. Additionally, the system may determine the following technique-specific pattern probabilities: P(M₁|t₁)=0.6, P(M₂|t₁)=0.4, P(M₃|t₁)=0.2, P(M₁|t₂)=0.1, P(M₂|t₂)=0.3, and P(M₃|t₂)=0.8. Additionally, the system may determine the following technique-specific device probabilities: P(D₁|t₁)=0.7, P(D₂|t₁)=0.1, P(D1₂|t₂)=0.3, and P(D₂|t₂)=0.9. Based on these values, the system may first compute

$${\prod }_{i = 1}^{\vert M \vert} {P ( {M}_{i} \vert {t}_{1} )}^{{w}_{i}} * {\prod }_{j = 1}^{\vert D \vert} P ( {D}_{j} \vert {t}_{1} ) = {P ( {M}_{1} \vert {t}_{1} )}^{{w}_{1}} * {P ( {M}_{2} \vert {t}_{1} )}^{{w}_{2}} * {P ( {M}_{3} \vert {t}_{1} )}^{{w}_{3}} * P ( {D}_{1} \vert {t}_{1} ) * P ( {D}_{2} \vert {t}_{1} ) = 0 . {6}^{1} * 0. {4}^{0.8} * 0. {2}^{1.2} * 0.7 * 0.1 = 0.0029$$

$$and$$

$${\prod }_{i = 1}^{\vert M \vert} {P ( {M}_{i} \vert {t}_{2} )}^{{w}_{i}} * {\prod }_{j = 1}^{\vert D \vert} P ( {D}_{j} \vert {t}_{2} ) = {P ( {M}_{1} \vert {t}_{2} )}^{{w}_{1}} * {P ( {M}_{2} \vert {t}_{2} )}^{{w}_{2}} * {P ( {M}_{3} \vert {t}_{2} )}^{{w}_{3}} * P ( {D}_{1} \vert {t}_{2} ) * P ( {D}_{2} \vert {t}_{2} ) = 0 . {1}^{1} * 0. {3}^{0.8} * 0. {8}^{1.2} * 0.3 * 0.9 = 0.0 78.$$

The system may then compute

$$( {D}_{1} , … , {D}_{\vert D \vert} ) = {\sum }_{k = 1}^{\vert t \vert} {\prod }_{j = 1}^{\vert D \vert} P ( {D}_{j} \vert t ) = 0.0078 + 0.00 \; 29 = 0.0107 .$$

The system may then compute

$$P ( {t}_{1} \vert M , D ) = \frac{{\prod }_{i = 1}^{\vert M \vert} {P ( {M}_{i} \vert {t}_{1} )}^{{w}_{i}} * {\prod }_{j = 1}^{\vert D \vert} P ( {D}_{j} \vert {t}_{1} )}{P ( {M}_{1} , … , {M}_{\vert M \vert} , {D}_{1} , … , {D}_{\vert D \vert} )} = \frac{0.0078}{0.107} = 0.72 = 72 \%$$

$$and$$

$$P ( {t}_{2} \vert M , D ) = \frac{{\prod }_{i = 1}^{\vert M \vert} {P ( {M}_{i} \vert {t}_{2} )}^{{w}_{i}} * {\prod }_{j = 1}^{\vert D \vert} P ( {D}_{j} \vert {t}_{2} )}{P ( {M}_{1} , … , {M}_{\vert M \vert} , {D}_{1} , … , {D}_{\vert D \vert} )} = \frac{0.0029}{0.107} = 0.27 = 27 \% .$$

This may indicate that the monitoring log(s) are likely associated with the Kerberoasting technique (t₁), as P(t₁|M, D)=0.72>P(t₂|M, D)=0.29.

In some cases, determining a posterior attack technique probability based on a Bayesian probability approach and/or based on one or more of the probabilities described above enables updating the probability across time as new monitoring log(s) are received (e.g., using a Bayesian updating technique). In some cases, during each time period, the system determines the attack technique probability (P(t)) associated with that period based on one or more posterior attack technique prior probabilities generated in one or more preceding iterations. For example, in some cases: (i) during an initial time period (e.g., an initial iteration), the system determines a posterior technique probability based on monitoring log sets associated with that period and a prior technique probability (e.g., a prior technique probability determined based on an expected prevalence of the attack technique), and (ii) during a subsequent time period (e.g., a subsequent iteration), the system determines a prior technique probability based on the posterior technique probability determined at the initial time period and monitoring log(s) associated with the subsequent period. This iterative updating approach enables the system to evaluate monitoring log(s) associated with a single period individually and to determine attack patterns that may be determined based on monitoring log(s) associated with a single period, instead of determining attack patterns that may span monitoring log(s) associated with two or more periods. Such a cross-period evaluation of monitoring log(s) may be computationally costly, for example as they may require applying complex heuristics that rely on event sequences. In this manner, the techniques described herein may improve computational efficiency of determining attack pattern(s) based on monitoring log(s) set(s) associated with two or more time periods.

In some cases, the iterative updating approach enables efficient updating of the attack technique probability over time as new monitoring log(s) becomes available. This approach may use Bayesian updating techniques to refine the assessment of the likelihood of an attack technique based on new monitoring log(s) and/or device profile detection(s). For example, in an initial iteration, the system may determine the posterior technique probability (P(t|M₀)) based on monitoring log(s) set(s) associated with the initial iteration (M₀) and a prior technique probability (P(t)₀). P(t)₀ may be determined based on the expected prevalence of the attack technique (e.g., as determined based on historical data, expert input(s), and/or machine learning model(s)). In each subsequent ith iteration, the system may: (i) determine a prior technique probability associated with the ith iteration (P(t)ᵢ) based on the posterior technique probability associated with the previous iteration (P(t|Mᵢ₋₁)) as determined based on monitoring log(s) associated with the previous iteration (Mᵢ₋₁), and (ii) determine the posterior technique probability associated with the ith distribution (P(t|Mᵢ)) based on the prior technique probability associated with the ith iteration (P(t)ᵢ). In some cases, this iterative update approach improves computational efficiency by: (i) updating the posterior technique probability based on the most recent monitoring log(s) and technique probabilities generated by previous iteration(s), (ii) eliminating and/or reducing the need for complex cross-period evaluation(s) and/or heuristic(s), (iii) focusing on evaluating monitoring log(s) within each individual time period, (iv) enabling incremental processing of monitoring log(s), and/or (v) enabling efficient handling of large volumes of monitoring log(s) by using knowledge obtained during previous iteration(s).

In some cases, the techniques described herein may further include using one or more decision tree models to determine an attack technique based on monitoring log(s). A decision tree model may represent a tree-like model of decisions and their possible consequences. In some cases, nodes of the tree may represent attack patterns and/or device profiles, branches of the tree may represent decisions and/or rules, and leaves of the tree may represent attack techniques. In some cases, the system may use the decision tree model to determine an attack technique by traversing the tree from its root node to a leaf node based on attack patterns and/or device profiles represented by and/or associated with the monitoring log(s).

In some cases, constructing the decision tree may include selecting a subset of attack patterns and/or a subset of device profiles that are most informative for distinguishing between different attack techniques. This selection may be performed using various techniques such as information gain, Gini impurity, and/or chi-squared tests. The selected subsets of attack patterns and/or device profiles may be used as the internal nodes of the tree, guiding the decision-making process. At each node, the decision tree may apply a specific condition and/or rule based on the presence and/or absence of certain attack patterns and/or device profiles. This condition may determine the branch to follow, ultimately leading to a leaf node that represents the most likely attack technique based on the provided monitoring log(s).

In some cases, the techniques described herein may further include using one or more heuristic models to determine an attack technique based on monitoring log(s). A heuristic model may represent a set of rules and/or conditions that, when satisfied by monitoring log(s), may indicate an increased likelihood of an attack technique. For example, a heuristic model may include a rule that specifies that if a particular sequence of attack patterns is observed within a specific time window, and if the devices involved in those attack patterns have specific device profiles, then a particular attack technique is likely to be occurring. The heuristic model may assign a confidence score to each rule, representing the strength of the association between the conditions specified in the rule and the corresponding attack technique.

In some cases, when the monitoring log(s) satisfy the conditions of a rule in the heuristic model, the system may increase the probability of the associated attack technique based on the confidence score of the rule. The system may then combine the probabilities obtained from the heuristic model with the probabilities calculated using the probabilistic model to obtain a final, refined assessment of the likelihood of each attack technique. This combination of probabilistic and heuristic approaches may enable the system to incorporate domain-specific knowledge and expert insights into the attack technique detection process, thus improving the accuracy and robustness of the results.

In some cases, the techniques described herein may further include using an attack chain as input to the attack technique determination model. An attack chain may represent a series of steps or stages that an attacker may follow to achieve their objectives, such as initial access, persistence, privilege escalation, lateral movement, and/or exfiltration. Each stage of the attack chain may involve the use of one or more attack techniques, and the specific techniques used may depend on the attacker's goals, capabilities, and/or the characteristics of the target environment.

In some cases, the system may use knowledge of common attack chains and/or the relationships between different attack techniques to improve the accuracy and/or efficiency of the attack technique detection process. For example, if the system detects an attack technique that is typically used in the initial stages of an attack chain, such as initial access or persistence, it may increase the probabilities and/or confidence scores of other attack techniques that are commonly used in subsequent stages of the same attack chain, such as lateral movement or exfiltration. This may enable the system to proactively identify and/or respond to potential threats before they fully materialize, by anticipating the attacker's likely next steps based on the attack techniques already detected.

In some cases, the system may use machine learning and/or data mining techniques to automatically learn common attack chains and/or the relationships between different attack techniques based on historical data and/or real-time monitoring log(s). For example, the system may analyze a large dataset of past security incidents and/or attacks to identify frequent sequences of attack techniques and/or the common transitions between distinct stages of an attack chain. The system may then use this learned knowledge to build an attack chain model that captures the probabilistic dependencies between different attack techniques and/or the likely progression of an attack over time.

In some cases, the attack chain model may be represented as a directed graph and/or a Markov chain, where nodes represent attack techniques and/or stages of an attack, and edges represent the probability and/or likelihood of transitioning from one technique or stage to another. The system may use this model to calculate the conditional probabilities of different attack techniques based on the techniques already detected and/or the current stage of the attack, and/or to predict the most likely next steps of an attacker based on their observed behavior so far.

In some cases, the system may use the attack chain model in conjunction with the other probabilistic models and/or heuristic models described herein to provide a more comprehensive and/or accurate assessment of the likelihood of different attack techniques based on the available monitoring log(s) and/or device profiles. For example, the system may use the attack chain model to adjust the prior probabilities and/or the technique-specific probabilities used in the Bayesian probability model, based on the conditional probabilities and/or the expected sequence of attack techniques in a given attack chain. This may help to reduce false positives and/or false negatives in the attack technique detection process, by taking into account the broader context and/or progression of an attack rather than just the individual indicators and/or patterns observed at a particular point in time.

In some cases, the techniques described herein may further include using the attack technique detection(s) to generate an automated response to an attack. The automated response may include one or more actions that the system may perform to mitigate the impact of the attack, prevent further spread of the attack, and/or gather additional information about the attack. The specific actions taken may depend on the detected attack technique(s), the devices and/or device profiles involved, the severity and/or confidence of the detection, and/or predefined security policies and/or response playbooks.

In some cases, the automated response may include isolating one or more devices from the network to prevent further communication with other devices and/or to stop the attack from spreading. This isolation may be achieved by configuring network devices such as firewalls, switches, and/or routers to block traffic to and/or from the affected devices. The system may also disable certain services, ports, and/or protocols on the isolated devices to further restrict their ability to communicate and/or cause harm.

In some cases, the automated response may include collecting additional data from the affected devices and/or the network for further analysis and/or forensic purposes. This data collection may involve capturing network traffic, system logs, memory dumps, and/or disk images from the devices. The collected data may be stored in a secure location and/or may be analyzed using various tools and/or techniques to gain more insights into the attack, such as identifying the initial entry point, the attack vector, the scope of the compromise, and/or the attacker's objectives and/or tactics, techniques, and/or procedures (TTPs).

In some cases, the automated response may include notifying relevant parties such as security personnel, incident response teams, and/or affected users about the detected attack. The notification may include details about the detected attack technique(s), the affected devices and/or device profiles, the severity and/or confidence of the detection, and/or the actions taken as part of the automated response. The notification may be delivered through various channels such as email, SMS, and/or instant messaging, and may be escalated based on predefined criteria such as the criticality of the affected devices and/or the potential impact of the attack.

In some cases, the automated response may include triggering one or more predefined playbooks and/or workflows based on the detected attack technique(s) and/or the affected devices and/or device profiles. A playbook may represent a set of predefined actions and/or steps that the system may perform in response to a specific type of attack and/or security incident. The playbook may include a combination of automated actions such as those described above, as well as manual actions that may require human intervention and/or approval. The system may use the attack technique detection(s) and/or the device profile(s) to select the appropriate playbook(s) to execute, and may adapt the playbook(s) based on the specific circumstances of the attack and/or the environment.

In some cases, the techniques described herein may further include using feedback from the automated response actions to refine the attack technique detection process. For example, if an automated response action such as isolating a device is successful in stopping an attack, this information may be used to increase the confidence score and/or probability associated with the corresponding attack technique detection. Conversely, if an automated response action is found to be ineffective or if it generates false positives, this information may be used to adjust the detection model and/or the associated probabilities and/or confidence scores. Over time, this feedback loop may enable the system to continuously improve its attack technique detection capabilities and/or its ability to generate effective automated responses based on those detections.

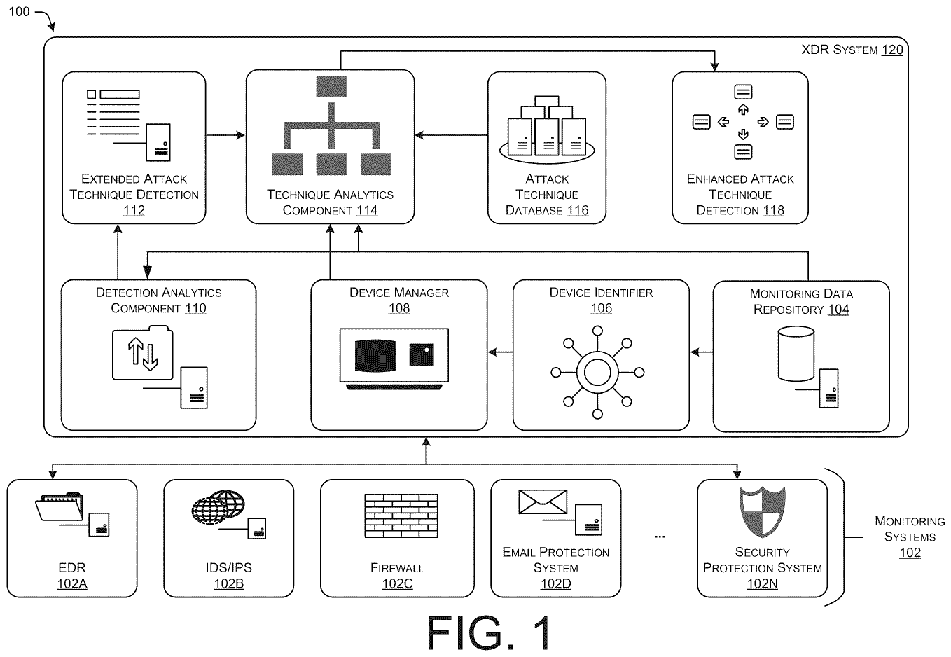

FIG. 1 depicts an example environment 100 with an Extended Detection and Response (XDR) system 120 that interacts with a set of monitoring systems 102. The monitoring systems 102 may include an EDR system 102A, an IDS/IPS 102B, a firewall engine 102C, an email protection system, and/or one or more other security protection systems 102N. While various implementations of the techniques described herein are described as being performed by an XDR system, a person of ordinary skill in the relevant technology will recognize that the disclosed techniques may be implemented by other computer security frameworks as well.

The EDR system 102A may monitor activity on endpoints such as servers, desktops, and laptops. The EDR system 102A may generate monitoring logs for suspicious or malicious activity observed on endpoints. The EDR system 102A may be implemented as agent software installed on each endpoint. The agent software may operate in the background by continuously collecting endpoint telemetry data and sending it to a central management console and/or the XDR system 120. The EDR agent may employ various techniques to detect threats, such as signature-based detection, behavioral analysis, and machine learning algorithms. Signature-based detection may include comparing observed activities against known patterns of malicious behavior or attack signatures. Behavioral analysis may include identifying anomalies and/or deviations from normal endpoint behavior which might indicate a potential threat. Additionally, machine learning algorithms may enhance detection capabilities by learning from historical data and adapting to new and emerging threats.

The IDS/IPS 102B may monitor network activity by analyzing network traffic. The IDS/IPS 102B may generate monitoring logs for anomalous network traffic and/or known attack patterns. To perform monitoring and detection operation, the IDS/IPS 102B may employ a combination of techniques, including signature-based detection, anomaly detection, and heuristic analysis. Signature-based detection may include comparing network traffic against a database of known attack patterns. Anomaly detection may include identifying deviations from normal network behavior, which could indicate possible intrusions and/or suspicious activities. Heuristic analysis may include applying predefined rules and behavioral models to detect threats. In some cases, the IDS/IPS 102B performs at least one of an IDS or an IPS functionality. The IDS functionality may identify suspicious or anomalous network behaviors, such as port scans, unusual data transfer patterns, and/or unauthorized access attempts. The IPS functionality may perform immediate action(s) to block or prevent identified threats from progressing further into the network. The IDS/IPS 102B may be implemented as a hardware or virtual network appliance deployed on the network. For example, the IDS/IPS 102B may be implemented as a hardware appliance installed at strategic points within the network infrastructure. Alternatively, the IDS/IPS 102B may be implemented as a virtual network appliance running on virtualized servers or cloud-based instances.

The firewall engine 102C may filter incoming and outgoing network traffic according to configured rules. The firewall engine 102C may generate monitoring logs when traffic is blocked or allowed. In some cases, the firewall engine 102C operates as a barrier between an internal network and an external network by controlling the flow of network traffic based on predefined rules. In some cases, the firewall engine 102C is configured to filter incoming and outgoing network traffic to enforce security policies and protect a network's assets from unauthorized access.

In some cases, when network packets are received at the firewall engine 102C, the received network packets are inspected against a set of predefined rules. These rules can be based on various criteria, such as source and destination IP addresses, port numbers, application protocols, or specific content within the packets. If a packet matches a rule for allowing network traffic, the firewall engine 102C may permit passage of the allowed packet through to the intended destination. On the other hand, if the packet matches a rule for denying network traffic, the firewall engine 102C may block the passage of the packet to prevent unauthorized access and/or to prevent potentially malicious traffic from entering and/or leaving the network. The firewall engine 102C may be implemented as a hardware and/or virtual network appliance.

The email protection system 102D may scan incoming and outgoing emails for malware and spam. The email protection system 102D may generate monitoring logs for blocked and/or allowed emails. The email protection system 102D may be implemented as a software service integrated with email servers. In some cases, the email protection system 102D continually evaluates the content, attachments, and/or sender reputation of incoming emails. To do so, the email protection system 102D may use databases of known threat patterns to identify and block emails that exhibit malicious behavior and/or contain harmful content. In some cases, the email protection system 102D processes outgoing emails to ensure that those outgoing emails do not inadvertently transmit sensitive information and/or include suspicious links and/or attachments. In some cases, whenever the email protection system 102D identifies a potentially malicious or spam email, the email protection system 102D generates one or more monitoring logs to record the identification. These monitoring logs can include details such as the sender's information, recipient details, timestamp, and/or a description of the threat and/or spam category.

Additional security protection systems 102N may perform other types of security monitoring and generate associated monitoring logs. Examples of such additional security protection systems 102N include Web Application Firewalls (WAFs), Data Loss Prevention (DLP) systems, Network Access Control (NAC) systems, threat intelligence platforms, advanced threat detection systems, Security Information and Alert Management (SIEM) systems, vulnerability management systems, and Endpoint Protection Platforms (EPPs).

As depicted in FIG. 1, the XDR system 120 receives the monitoring logs generated by the monitoring systems 102 and stores those logs on a monitoring data repository 104. The monitoring data repository 104 may be a storage framework for collecting, storing, and/or analyzing the monitoring logs generated by the various monitoring systems 102. The monitoring data repository 104 may receive the monitoring logs in real-time from the monitoring systems 102 and the received logs in a structured and/or semi-structured format for efficient retrieval and/or analysis. The monitoring data repository 104 may be implemented using a database, data warehouse, and/or cloud storage. If implemented as a database, the monitoring data repository 104 may utilize NoSQL databases like Apache Cassandra or MongoDB to provide horizontal scaling capabilities to handle large volumes of data. If implemented as a data warehouse, the monitoring data repository 104 may use solutions like Amazon Redshift or Google BigQuery to enable complex analytics and/or reporting on historical data. If implemented as a cloud storage solution, the monitoring data repository 104 may use cloud-based object storage services like Amazon S3 or Microsoft Azure Blob Storage.

The monitoring log(s) stored on the monitoring data repository 104 are processed by a device identifier 106 that identifies device(s) affected by the monitoring log(s). The device identifier 106 may be configured to determine that two device identifiers used in two different monitoring logs (e.g., in monitoring log sets generated by two or more monitoring systems) are associated with a common device. Example techniques for device identification based on monitoring data generated by two or more monitoring systems are described in U.S. patent application Ser. No. 18/453,960, entitled “Tracking Computer Devices in Extended Detection and Response Systems” and filed on Apr. 24, 2023, which is incorporated by reference herein in its entirety and for all purposes.

A device manager 108 may generate one or more device profiles associated with the one or more devices identified by the device identifier 106. In some cases, the device manager 108 generates a profile of the devices (hosts, machines, and/or the like) observed in the monitoring log data. For example, the device manager 108 may extracts device-related information, such as IP addresses, hostnames, and/or unique identifiers from the monitoring log(s) to create and/or update device profile(s) associated with identified device(s). A device profile may include information about a devices' historical behavior, security posture, associated users, and/or other relevant attributes. Example techniques for generating device profiles associated with devices are described above.

As further depicted in FIG. 1, a detection analytics component 110 may process the device profile(s) generated by the device manager 108 and the monitoring log(s) stored on the monitoring data repository 104 to determine an extended attack technique detection 112. The extended attack technique detection 112 includes a list of potential attack techniques that may be detected based on the monitoring data and device profiles.

The detection analytics component 110 may be configured to process the monitoring log(s) stored in the monitoring data repository 104 to determine that the monitoring log(s) represent a potential attack as well as a set of potential attack techniques associated with that attack. Such information may be stored in an extended attack technique detection 112. The extended attack technique detection 112 may, for example, store a list of potential attack techniques associated with a detected attack. This list may, for example, based on one or more heuristics and/or rules, such as heuristic(s) and/or rule(s) represented by the attack technique database 116 (e.g., by a knowledge base of known attack techniques, such as the MITRE ATT&CK framework).

The technique analytics component 114 may be configured to process the device profile(s) generated by the device manager 108, process the monitoring log(s) stored in the monitoring data repository 104, and/or heuristic(s) and/or rule(s) represented by the attack technique database 116 to determine an enhanced attack technique detection 118. The enhanced attack technique detection 118 may include a subset (e.g., a ranked subset) of likely attack techniques from the list of potential attack techniques represented by the extended attack technique detection 112. In some cases, to determine the likely attack technique(s) from a list of potential attack techniques, the technique analytics component 114: (i) determines a posterior attack technique probability for each potential attack technique based on the monitoring log(s) and/or the device profile(s) (e.g., using the techniques described above), and/or (ii) determines a subset of the potential attack techniques based on the determined probabilities (e.g., selects the N potential attack techniques having the top N posterior technique probabilities, selects each potential attack technique whose respective posterior probability exceeds a threshold, and/or the like).

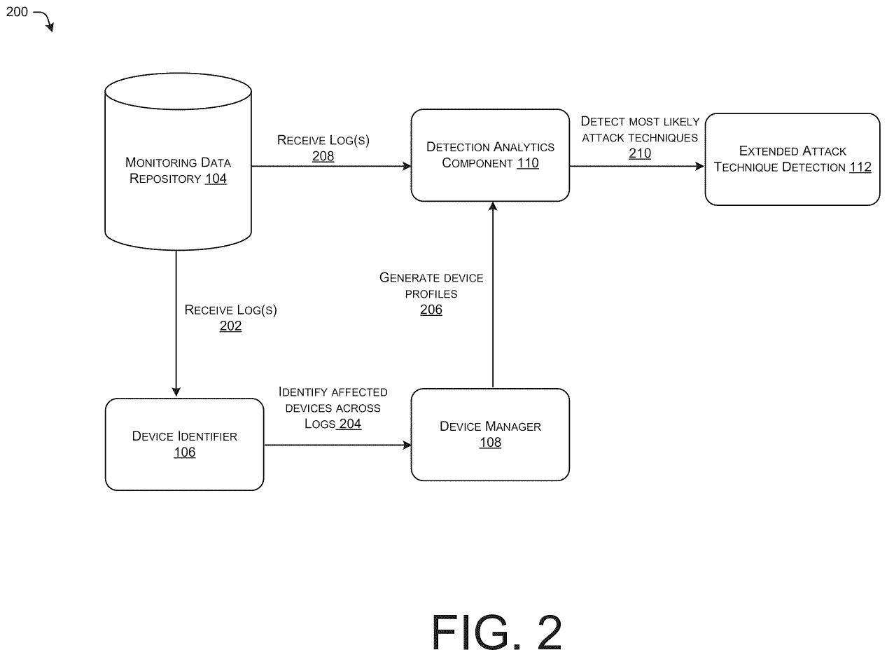

FIG. 2 is a data flowchart datagram of an example process 200 for determining an extended attack technique detection with a list of potential attack techniques. As depicted in FIG. 2, at operation 202, the device identifier 106 receives one or more monitoring log sets from the monitoring data repository 104. Each monitoring log set may be generated by one of one or more monitoring systems. The monitoring log(s) may represent monitoring data, attack patterns, indicators of compromise, and/or other relevant information collected by the monitoring systems 102 and/or stored in the monitoring data repository 104.

At operation 204, the device identifier 106 identifies one or more affected devices based on the one or more monitoring log sets. Example techniques for device identification based on monitoring log(s) are described above.

At operation 206, the device manager 108 generates device profile(s) for the identified device(s). In some cases, to generate the device profile(s), the device manager 108 generates and/or retrieves device attributes associated with the one or more affected devices identified by the device identifier 106. The device attributes may include device types, device configurations, software versions, patch levels, known vulnerabilities, and/or other relevant characteristics of the affected devices. The device manager 108 may receive these attributes from various sources, such as asset management systems, configuration management databases, vulnerability scanners, and/or other tools and/or systems that collect and/or maintain information about devices in a monitored computing and/or network environment.

At operation 208, the detection analytics component 110 receives one or more monitoring log sets from the monitoring data repository 104. The detection analytics component 110 may receive these log(s) on a continuous and/or periodic basis, and/or may query the monitoring data repository 104 for specific log(s) based on certain criteria and/or conditions.

At operation 210, the detection analytics component 110 generates the extended attack technique detection 112 based on the monitoring log(s) received from the monitoring data repository 104 and/or the device profile(s) generated by the device manager 108. The extended attack technique detection 112 may, for example, store a list of potential attack techniques associated with a detected attack. Example techniques for generating the extended attack technique detection 112 are described above.

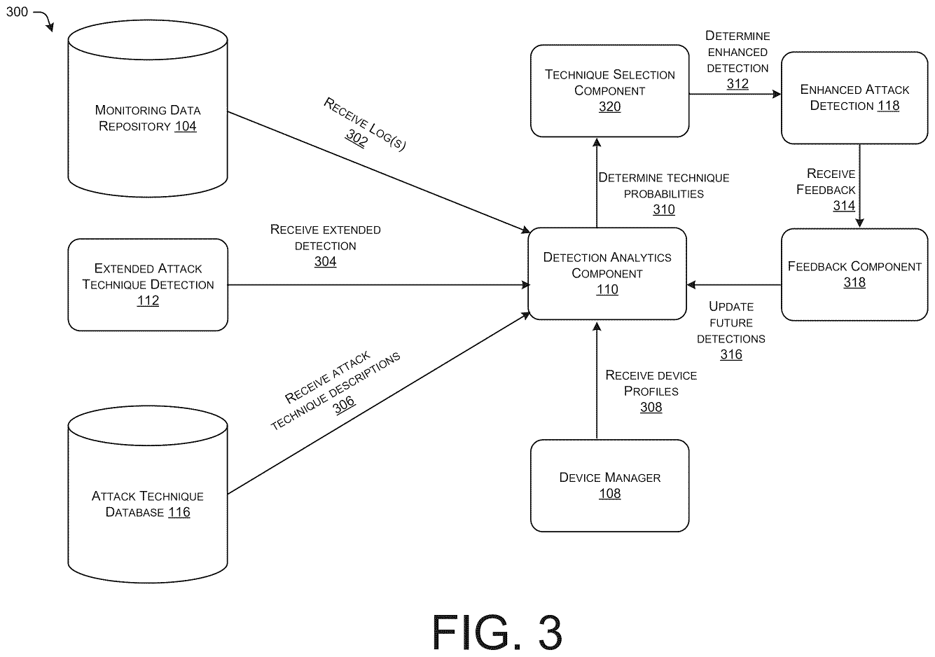

FIG. 3 is a data flowchart diagram of an example process 300 for determining an enhanced attack technique detection 118 with a set of likely attack techniques selected from a list of potential attack techniques, as included in the extended attack technique detection 112. As depicted in FIG. 3, the detection analytics component 110 receives one or more monitoring logs from the monitoring data repository 104 at operation 302, receives an extended attack technique detection 112 representing a list of potential attack techniques at operation 304, receives attack technique descriptions for a set of attack techniques (e.g., including the potential attack techniques represented by the extended attack technique detection 112) at operation 306, receives one or more device profiles associated with one or more affected devices (e.g., affected by the event(s) represented by the received monitoring log(s)) at operation 308.

At operation 310, the detection analytics component 110 determines a set of posterior technique probabilities each associated with one of the potential attack techniques represented by the extended attack technique detection 112. The detection analytics component 110 may determine the posterior technique probabilities based on the monitoring log(s), the attack technique descriptions, and/or the device profile(s). Example techniques for determining posterior attack technique probabilities are described above.

At operation 312, a technique selection component 320 selects a subset of the potential attack techniques represented by the extended attack technique detection 112 based on the posterior technique probabilities generated by the detection analytics component 110. For example, in some cases, the technique selection component 320 selects the N potential attack techniques having the top N posterior technique probabilities, selects each potential attack technique whose respective posterior probability exceeds a threshold, and/or the like. As depicted in FIG. 3, the potential attack techniques selected by the technique selection component 320 may be included in an enhanced attack technique detection 118.

At operation 314, a feedback component 318 receives feedback about the selected attack techniques. The feedback may represent an input from a security analyst, a security tool, and/or another system component about the accuracy, relevance, and/or usefulness of the attack techniques included in the enhanced attack technique detection 118. For example, the feedback may indicate whether a particular attack technique was correctly identified, whether it was a false positive, and/or whether it provided valuable insights for detecting and/or mitigating an actual attack.

At operation 316, the detection analytics component 110 receives the feedback and uses the feedback to update the probabilities used to determine the posterior attack technique probabilities. For example, the detection analytics component 110 may use the feedback to update technique-specific pattern probabilities, technique-specific device probabilities, reliability weight(s), attack pattern heuristics, technique probabilities, and/or pattern probabilities.

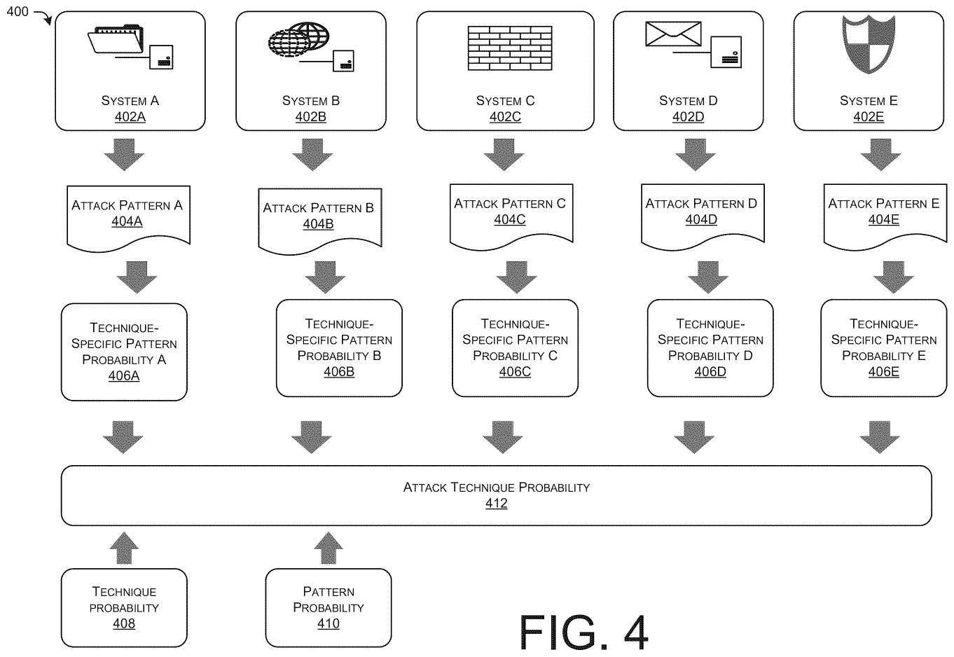

FIG. 4 provides an operational example 400 of determining a posterior attack technique probability 412 associated with an attack technique based on attack patterns represented by one or more monitoring log set(s). As depicted in FIG. 4, five attack patterns are generated, each based on a monitoring log set generated by one of five monitoring systems. Specifically, attack pattern A 404A is determined based on a monitoring log set generated by a system A 402A, attack pattern B 404B is determined based on a monitoring log set generated by a system B 402B, attack pattern C 404C is determined based on a monitoring log set generated by a system C 402C, attack pattern D 404D is determined based on a monitoring log set generated by a system D 402D, and attack pattern E 404E is determined based on a monitoring log set generated by a system E 402E. Example techniques for determining attack patterns based on monitoring log set(s) are described above.

As further depicted in FIG. 4, five technique-specific patent probabilities (e.g., P(t|Mᵢ) values) are determined based on the five attack patterns. Specifically, the technique-specific pattern probability A 406A is determined based on attack pattern A 404A, the technique-specific pattern probability B 406B is determined based on attack pattern B 404B, the technique-specific pattern probability C 406C is determined based on attack pattern C 404C, the technique-specific pattern probability D 406D is determined based on attack pattern D 404D, and the technique-specific pattern probability E 406E is determined based on attack pattern E 404E. Example techniques for determining technique-specific pattern probabilities based on attack patterns are described above.

As further depicted in FIG. 4, the system determines the posterior attack technique probability 412 based on the five technique-specific pattern probabilities, a technique probability 408 (e.g., P(t)) and a pattern probability 410 (e.g., P(M₁, . . . , Mᵢ)). Example techniques for determining technique probabilities, pattern probabilities, and/or posterior attack technique probabilities based on technique-specific pattern probabilities, technique probabilities, and/or pattern probabilities are described above.

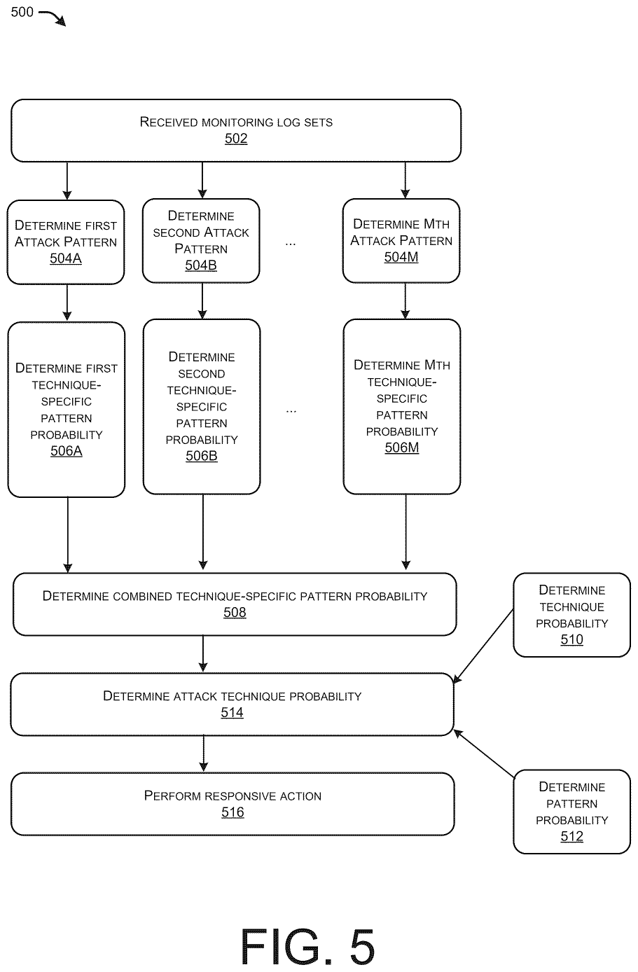

FIG. 5 is a flowchart diagram of an example process 500 for responding to computer network attacks based on attack technique probabilities. As depicted in FIG. 5, at operation 502, an example system receives one or more monitoring log sets (e.g., M monitoring log sets each generated by one of M monitoring systems). Afterward, the system determines M attack patterns based on the received monitoring log set(s) (e.g., determines each of the M attack patterns based on a respective one of M received monitoring log sets). For example, the system may determine a first attack pattern at operation 504A, a second attack pattern at operation 504B, and an Mth attack pattern at operation 504M.

As further depicted in FIG. 5, the system next determines M technique-specific pattern probabilities (e.g., P(t|Mᵢ) values), each associated with one of the M determined attack patterns. For example, the system may determine a first technique-specific associated with the first attack pattern at operation 506A, a second technique-specific associated with the second attack pattern at operation 506B, and an Mth technique-specific associated with the second Mth pattern at operation 506M. Example techniques for determining technique-specific pattern probabilities based on attack patterns are described above.

At operation 508, the system determines a combined technique-specific pattern probability based on the M technique-specific pattern probabilities. For example, the system may combine the M technique-specific pattern probabilities based on M reliability weights associated with the M attack patterns to determine the combined technique-specific pattern probability. Example techniques for determining the combined technique-specific pattern probability are described above, for example with reference to Equations 1-3.

At operation 510, the system determines a prior technique probability (P(t)). The technique probability may be determined based on: (i) an expected probability of occurrence of the technique pattern independent of the monitoring log set(s), and/or (ii) the posterior technique probability generated by a preceding time and/or iteration. Example techniques for determining prior technique probabilities are described above.

At operation 512, the system determines a pattern probability. The pattern probability may represent a probability of observing the M attack patterns. Example techniques for determining the pattern probability are described above.

At operation 514, the system determines the posterior attack technique probability based on the combined technique-specific pattern probability, the prior technique probability, and/or the pattern probability. Example techniques for determining the posterior attack technique probability are described above, for example with reference to Equations 1-4.

At operation 516, the system performs a responsive action based on the attack technique probability. In some cases, the system: (i) determines that the monitoring log(s) are associated with the attack technique based on the posterior attack technique probability (e.g., based on determining that the posterior attack technique probability exceeds a threshold and/or is among the N attack techniques with the top N posterior attack technique probabilities among a set of potential attack techniques), and (ii) based on determining that the monitoring log(s) are associated with the attack technique, performs the responsive action. The responsive action may include initiating an automated remedial action, providing an alert to a user (e.g., to a security analyst using the XDR system), blocking access by a device that is determined be affected by an attack technique to a computer network and/or to a network device (e.g., a network device associated with a network service), monitoring network traffic associated with the affected device, and/or quarantining the affected device.

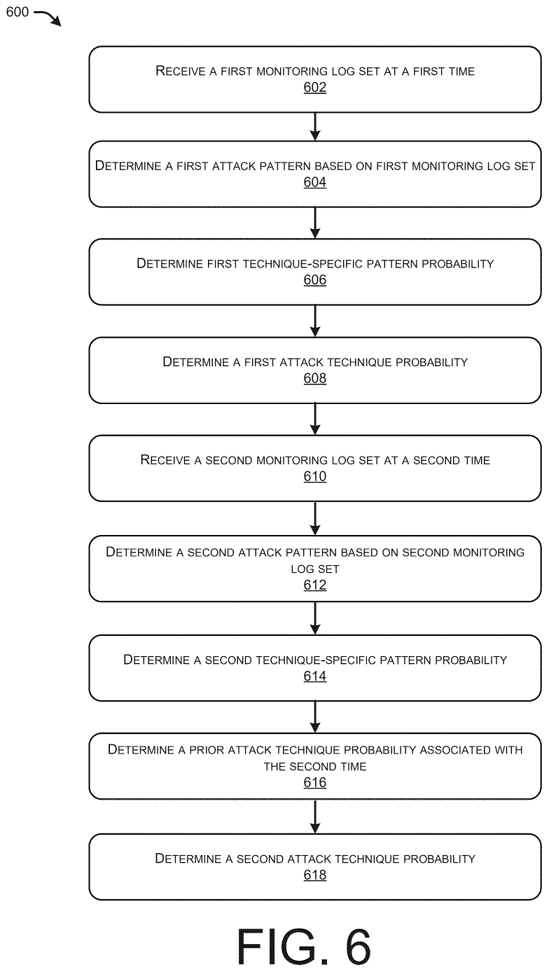

FIG. 6 is a flowchart diagram of an example process 600 for determining an attack technique based on monitoring log sets associated with two or more times. As depicted in FIG. 6, at operation 602, an example system receives a first monitoring log set at a first time. The first monitoring log set may be received from one or more monitoring systems, as explained in greater detail above.

At operation 604, the system determines a first attack pattern based on the first monitoring log set. The first attack pattern may represent one or more events, sequences, and/or indicators identified in the first monitoring log set that are associated with a particular attack technique. Example techniques for determining attack patterns based on monitoring log sets are described in greater detail above.

At operation 606, the system determines a first technique-specific pattern probability based on the first attack pattern. The first technique-specific pattern probability may represent a conditional probability of observing the first attack pattern given the occurrence of the attack technique, as explained in greater detail above.

At operation 608, the system determines a first posterior attack technique probability based on the first technique-specific pattern probability. In some cases, the system may determine the first posterior attack technique probability based on the first technique-specific pattern probability, a technique-specific device probability, a technique probability, and/or a pattern probability.

At operation 610, the system receives a second monitoring log set at a second time, which is different from the first time. The second monitoring log set may be received from the same monitoring system(s) as the first monitoring log set or from different monitoring system(s), as explained in greater detail above.

At operation 612, the system determines a second attack pattern based on the second monitoring log set. The second attack pattern may represent one or more events, sequences, and/or indicators identified in the second monitoring log set that are associated with the same attack technique as the first attack pattern or a different attack technique. Example techniques for determining attack patterns based on monitoring log sets are described in greater detail above.

At operation 614, the system determines a second technique-specific pattern probability based on the second attack pattern. The second technique-specific pattern probability may represent a conditional probability of observing the second attack pattern given the occurrence of the attack technique, as explained in greater detail above.

At operation 616, the system determines a prior attack technique probability associated with the second time. The system may determine the prior attack technique probability associated with the second time based on the first posterior attack technique probability. For example, the system may adopt the first posterior attack technique probability as the prior attack technique probability associated with the second time.

At operation 618, the system determines a second posterior attack technique probability associated with the second time based on the second technique-specific pattern probability and the prior attack technique probability. Example techniques for determining a posterior attack technique probability based on a technique-specific pattern probability and a prior attack probability are described above, for example in relation to Equations 1-4.

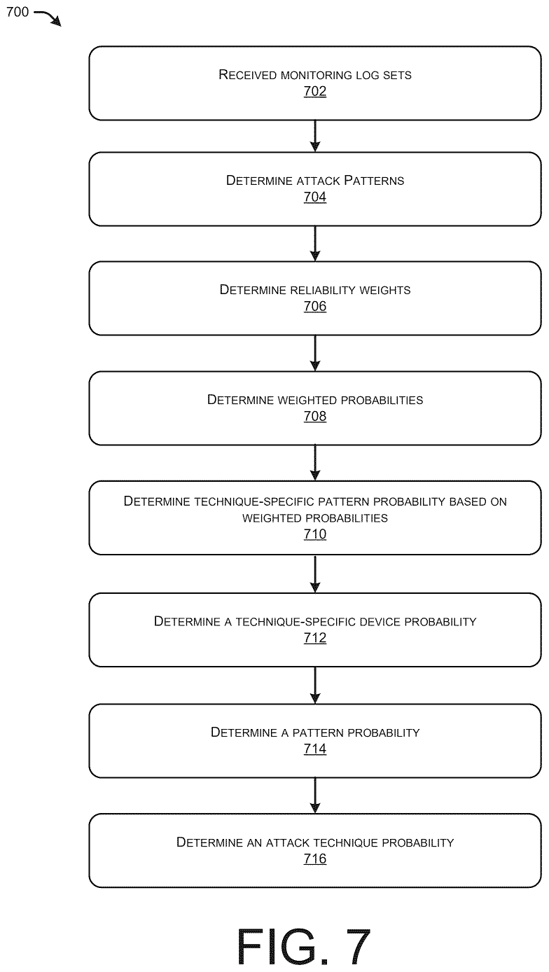

FIG. 7 is a flowchart diagram of an example process 700 for determining an attack technique probability based on monitoring log sets, attack patterns, reliability weights, and/or device profiles. As depicted in FIG. 7, at operation 702, the system receives monitoring log sets from one or more monitoring systems. The monitoring log sets may include various represent events and/or detections related to the security and/or performance of a computer network, as explained in greater detail above.

At operation 704, the system determines attack patterns based on the received monitoring log sets. Attack patterns may be specific combinations of events, behaviors, and/or indicators that are associated with particular attack techniques. Example techniques for determining attack patterns based on monitoring logs are described above.

At operation 706, the system determines reliability weights for the attack patterns. Reliability weights may represent a level of confidence in accurate detection of an attack pattern. Example techniques for determining reliability weights for attack patterns are described above.

At operation 708, the system determines weighted probabilities for each attack pattern. The weighted probability associated with an attack pattern may be determined based on the technique-specific pattern probability associated with that attack pattern and the reliability weight associated with that attack pattern. For example, the weighted probability associated with an attack pattern may be determined by raising the technique-specific pattern probability associated with that attack pattern to the power of the reliability weight associated with that attack pattern, for example as described above in relation to Equations 1-3.

At operation 710, the system determines a technique-specific pattern probability based on combining the weighted probabilities associated with the attack patterns. The technique-specific pattern probability represent the likelihood of the attack technique occurring given the observed attack patterns and their reliability weights. Example techniques for determining a technique-specific pattern probability based on combining the weighted probabilities associated with the attack patterns are described above, for example in relation to Equations 1-3.

At operation 712, the system determines a technique-specific device probability based on one or more device profiles associated with one or more devices affected by the attack technique. The device profile(s) may contain information about the attributes, characteristics, configurations, and/or vulnerabilities of the device(s). Example techniques for determining device profiles and technique-specific device probabilities are described above.

At operation 714, the system determines a pattern probability. The pattern probability may represent the overall likelihood of observing the attack patterns and/or involvement of the device profile(s). Example techniques for determining pattern probabilities are described above.

At operation 716, the system determines an attack technique probability based on the pattern probability, the technique-specific pattern probability, and the technique-specific device probability. Example techniques for determining a posterior attack technique probability based on a pattern probability, a technique-specific pattern probability, and a technique-specific device probability are described above, for example with reference to Equations 1-4.

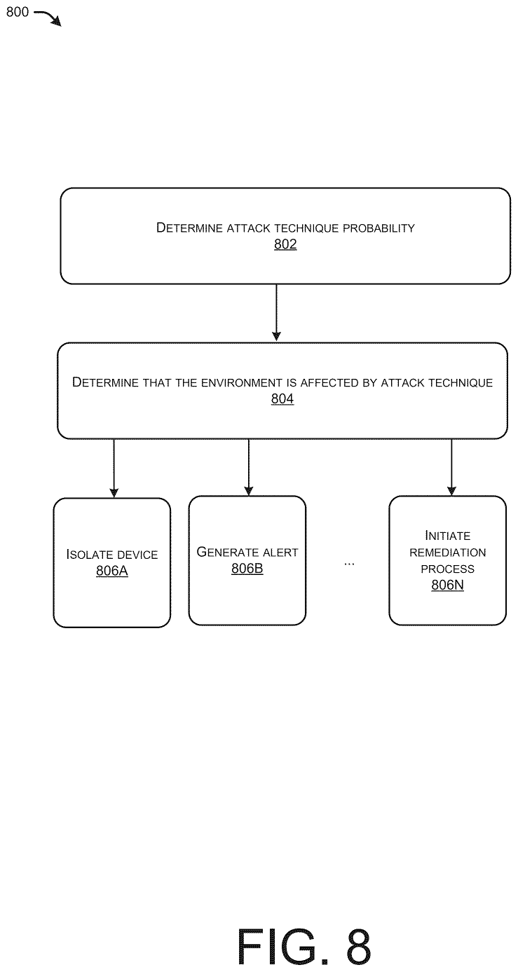

FIG. 8 is a flowchart diagram of an example process 800 for responding to an attack associated with an attack technique. As depicted in FIG. 8, at operation 802, an example system determines an attack technique probability associated with an attack technique. The attack technique probability may represent the likelihood that a network environment is affected by the particular attack technique. Example techniques for determining an attack technique probability are described above, for example with reference to Equations 1-4.

At operation 804, the system determines that the network environment is affected by the attack technique based on the attack technique probability. For example, the system may determine that the network environment is affected by the attack technique based on determining that the attack technique probability exceeds a threshold and/or is among the N attack techniques with the top N attack technique probabilities among a set of potential attack techniques.

In some cases, because the system determines that the device is affected by the attack technique, the system may perform one or more responsive actions, for example as shown in operations 806A, 806B, and 806N. The specific responsive actions may vary depending on the severity, scope, and/or nature of the attack technique the security policies and/or priorities of the network environment, and/or the like.

For example, at operation 806A, the system may isolate an affected device from the network to prevent further spread of the attack and/or exfiltration of sensitive data. This isolation may involve disconnecting the device from the network, revoking its access privileges, and/or applying network segmentation and/or containment measures.

As another example, at operation 806B, the system may generate an alert to notify security personnel and/or incident response teams about the detected attack technique and the affected device. The alert may contain information about the attack technique, its probability, the device profile, and/or recommended actions for investigation and remediation.

As another example, at operation 806N, the system may initiate a remediation process to eliminate the attack technique from the affected device and/or restore it to a secure state. The remediation process may involve applying security patches, resetting passwords, removing malware, restoring from clean backups, and/or the like.

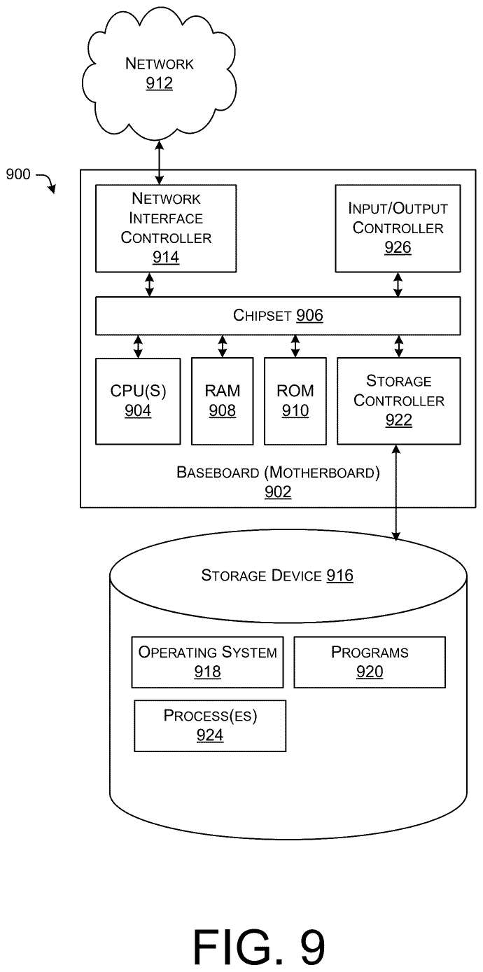

FIG. 9 shows an example computer architecture for a server computer 900 capable of executing program components for implementing the functionality described above. The computer architecture shown in FIG. 9 illustrates a conventional server computer, workstation, desktop computer, laptop, tablet, network appliance, e-reader, smartphone, or other computing device, and can be utilized to execute any of the software components presented herein. The server computer 900 may, in some examples, correspond to a network node (e.g., the 9) described herein.

The computer 900 includes a baseboard 902, or “motherboard,” which is a printed circuit board to which a multitude of components or devices can be connected by way of a system bus or other electrical communication paths. In one illustrative configuration, one or more central processing units (“CPUs”) 904 operate in conjunction with a chipset 906. The CPUs 904 can be standard programmable processors that perform arithmetic and logical operations necessary for the operation of the computer 900.

The CPUs 904 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 906 provides an interface between the CPUs 904 and the remainder of the components and devices on the baseboard 902. The chipset 906 can provide an interface to a random-access memory (RAM) 908, used as the main memory in the computer 900. The chipset 906 can further provide an interface to a computer-readable storage medium such as a read-only memory (ROM) 910 or non-volatile RAM (NVRAM) for storing basic routines that help to start up the computer 900 and to transfer information between the various components and devices. The ROM 910 or NVRAM can also store other software components necessary for the operation of the computer 900 in accordance with the configurations described herein.

The computer 900 can operate in a networked environment using logical connections to remote computing devices and computer systems through a network, such as the network 912. The chipset 906 can include functionality for providing network connectivity through a network interface controller (NIC) 914, such as a gigabit Ethernet adapter. The NIC 914 is capable of connecting the computer 900 to other computing devices over the network 912. It should be appreciated that multiple NICs 914 can be present in the computer 900, connecting the computer 900 to other types of networks and remote computer systems. In some instances, the NICs 914 may include at least on ingress port and/or at least one egress port.

The computer 900 can be connected to a storage device 916 that provides non-volatile storage for the computer. The storage device 916 can store an operating system 918, programs 920, and data, which have been described in greater detail herein. The storage device 916 can be connected to the computer 900 through a storage controller 922 connected to the chipset 906. The storage device 916 can consist of one or more physical storage units. The storage device 916 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 900 can store data on the storage device 916 by transforming the physical state of the physical storage units to reflect the information being stored. The specific transformation of physical state can depend on several factors, in different embodiments of this description. Examples of such factors can include, but are not limited to, the technology used to implement the physical storage units, whether the storage device 916 is characterized as primary or secondary storage, and the like.

For example, the computer 900 can store information to the storage device 916 by issuing instructions through the storage controller 922 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 900 can further read information from the storage device 916 by detecting the physical states or characteristics of one or more particular locations within the physical storage units.

In addition to the mass storage device 916 described above, the computer 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 900. In some examples, the operations performed by any network node described herein may be supported by one or more devices similar to computer 900. Stated otherwise, some or all of the operations performed by a network node may be performed by one or more computer devices operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 916 can store an operating system 918 utilized to control the operation of the computer 900. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 916 can store other system or application programs and data utilized by the computer 900.

In one embodiment, the storage device 916 or other computer-readable storage media is encoded with computer-executable instructions which, when loaded into the computer 900, transform the computer from a general-purpose computing system into a special-purpose computer capable of implementing the embodiments described herein. These computer-executable instructions transform the computer 900 by specifying how the CPUs 904 transition between states, as described above. According to one embodiment, the computer 900 has access to computer-readable storage media storing computer-executable instructions which, when executed by the computer 900, perform the various processes described above with regard to FIGS. 1-YY. The computer 900 can also include computer-readable storage media having instructions stored thereupon for performing any of the other computer-implemented operations described herein.

As illustrated in FIG. 9, the storage device 916 stores programs 920, which may include one or more processes 924, as well as YY. The processes 924 may include instructions that, when executed by the CPU(s) 904, cause the computer 900 and/or the CPU(s) 904 to perform one or more operations.

The computer 900 can also include at least one input/output controller 926 for receiving and processing input from a number of input devices, such as a keyboard, a mouse, a touchpad, a touch screen, an electronic stylus, or other type of input device. Similarly, an input/output controller 926 can provide output to a display, such as a computer monitor, a flat-panel display, a digital projector, a printer, or other type of output device. It will be appreciated that the computer 900 might not include all of the components shown in FIG. 9, can include other components that are not explicitly shown in FIG. 9, or might utilize an architecture completely different than that shown in FIG. 9.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, by a processor, a plurality of monitoring log sets from a plurality of monitoring systems, the plurality of monitoring systems being configured to monitor a computer network;
determining, by the processor, a first pattern based on a first monitoring log set of the plurality of monitoring log sets, the first monitoring log set received from a first monitoring system of the plurality of monitoring systems;
determining, by the processor, a second pattern based on a second monitoring log set of the plurality of monitoring log sets, the second monitoring log set received from a second monitoring system of the plurality of monitoring systems;
determining, by the processor, a first weighted probability of occurrence of an attack technique based on the first pattern and a first reliability weight, the first reliability weight being associated with the first monitoring system;
determining, by the processor, a second weighted probability of occurrence of the attack technique based on the second pattern and a second reliability weight, the second reliability weight being associated with the second monitoring system;
determining, by the processor, a first probability based on the first weighted probability and the second weighted probability, the first probability being associated with the plurality of monitoring log sets and the attack technique;
determining, by the processor, a second probability of occurrence of the attack technique in relation to a first device attribute associated with the computer network;
determining, by the processor and based on the first probability and the second probability, first data representing that the computer network is affected by the attack technique; and
performing, by the processor, a responsive action based on the first data.

2. The method of claim 1, wherein determining the first data comprises:
determining a third probability associated with observing the first pattern and the second pattern and with involvement of the first device attribute; and
determining the first data based on the first probability, the second probability, and the third probability.

3. The method of claim 2, wherein determining the third probability comprises:
determining a third weighted probability of occurrence of a second attack technique based on the first pattern and the first reliability weight;
determining a fourth weighted probability of occurrence of the second attack technique based on the second pattern and the second reliability weight;
determining a fourth probability based on the third weighted probability and the fourth weighted probability;
determining a fifth probability of occurrence of the second attack technique in relation to the first device attribute; and
determining the third probability based on the fourth probability and the fifth probability.

4. The method of claim 1, wherein the first probability represents a probability of occurrence of the attack technique given observing a plurality of patterns represented by the plurality of monitoring log sets, the plurality of patterns comprising the first pattern and the second pattern.

5. The method of claim 1, wherein the responsive action comprises at least one of:
generating an alert indicating the computer network is affected by the attack technique;
isolating a device from the computer network; or
initiating a remediation process to mitigate effects of the attack technique on the device.

6. The method of claim 1, wherein determining the first data comprises:
determining a third probability associated with an expected likelihood of occurrence of the attack technique; and
determining the first data based on the first probability, the second probability, and the third probability.

7. The method of claim 6, wherein the plurality of monitoring log sets are associated with a first period, and wherein determining the third probability comprises:
determining a fourth probability of occurrence of the attack technique given a second plurality of monitoring log sets, the second plurality of monitoring log sets being associated with a second period; and
determining the third probability based on the fourth probability.

8. A system comprising one or more processors and one or more computer-readable media storing computer-executable instructions that, when executed by the one or more processors, cause the one or more processors to perform operations comprising:
receiving a plurality of monitoring log sets from a plurality of monitoring systems, the plurality of monitoring systems being configured to monitor a computer network;
determining a first pattern based on a first monitoring log set of the plurality of monitoring log sets, the first monitoring log set received from a first monitoring system of the plurality of monitoring systems;
determining a second pattern based on a second monitoring log set of the plurality of monitoring log sets, the second monitoring log set received from a second monitoring system of the plurality of monitoring systems;
determining a first weighted probability of occurrence of an attack technique based on the first pattern and a first reliability weight, the first reliability weight being associated with the first monitoring system;
determining a second weighted probability of occurrence of the attack technique based on the second pattern and a second reliability weight, the second reliability weight being associated with the second monitoring system;
determining a first probability based on the first weighted probability and the second weighted probability, the first probability being associated with the plurality of monitoring log sets and the attack technique;
determining a second probability of occurrence of the attack technique in relation to a first device attribute associated with the computer network;
determining, based on the first probability and the second probability, first data representing that the computer network is affected by the attack technique; and
performing a responsive action based on the first data.

9. The system of claim 8, wherein determining the first data comprises:
determining a third probability associated with observing the first pattern and the second pattern and with involvement of the first device attribute; and
determining the first data based on the first probability, the second probability, and the third probability.

10. The system of claim 9, wherein determining the third probability comprises:
determining a third weighted probability of occurrence of a second attack technique based on the first pattern and the first reliability weight;
determining a fourth weighted probability of occurrence of the second attack technique based on the second pattern and the second reliability weight;
determining a fourth probability based on the third weighted probability and the fourth weighted probability;
determining a fifth probability of occurrence of the second attack technique in relation to the first device attribute; and
determining the third probability based on the fourth probability and the fifth probability.

11. The system of claim 8, wherein the first probability represents a probability of occurrence of the attack technique given observing a plurality of patterns represented by the plurality of monitoring log sets, the plurality of patterns comprising the first pattern and the second pattern.

12. The system of claim 8, wherein the responsive action comprises at least one of:
generating an alert indicating the computer network is affected by the attack technique;
isolating a device from the computer network; or
initiating a remediation process to mitigate effects of the attack technique on the device.

13. The system of claim 8, wherein determining the first data comprises:
determining a third probability associated with an expected likelihood of occurrence of the attack technique; and
determining the first data based on the first probability, the second probability, and the third probability.

14. The system of claim 13, wherein the plurality of monitoring log sets are associated with a first period, and wherein determining the third probability comprises:
determining a fourth probability of occurrence of the attack technique given a second plurality of monitoring log sets, the second plurality of monitoring log sets being associated with a second period; and
determining the third probability based on the fourth probability.

15. One or more non-transitory computer-readable media storing computer-executable instructions that, when executed by one or more processors, cause the one or more processors to perform operations comprising:
receiving a plurality of monitoring log sets from a plurality of monitoring systems, the plurality of monitoring systems being configured to monitor a computer network;
determining a first pattern based on a first monitoring log set of the plurality of monitoring log sets, the first monitoring log set received from a first monitoring system of the plurality of monitoring systems;
determining a second pattern based on a second monitoring log set of the plurality of monitoring log sets, the second monitoring log set received from a second monitoring system of the plurality of monitoring systems;
determining a first weighted probability of occurrence of an attack technique based on the first pattern and a first reliability weight, the first reliability weight being associated with the first monitoring system;
determining a second weighted probability of occurrence of the attack technique based on the second pattern and a second reliability weight, the second reliability weight being associated with the second monitoring system;
determining a first probability based on the first weighted probability and the second weighted probability, the first probability being associated with the plurality of monitoring log sets and the attack technique;
determining a second probability of occurrence of the attack technique in relation to a first device attribute associated with the computer network;
determining, based on the first probability and the second probability, first data representing that the computer network is affected by the attack technique; and
performing a responsive action based on the first data.

16. The one or more non-transitory computer-readable media of claim 15, wherein determining the first data comprises:
determining a third probability associated with observing the first pattern and the second pattern and with involvement of the first device attribute; and
determining the first data based on the first probability, the second probability, and the third probability.

17. The one or more non-transitory computer-readable media of claim 16, wherein determining the third probability comprises:
determining a third weighted probability of occurrence of a second attack technique based on the first pattern and the first reliability weight;
determining a fourth weighted probability of occurrence of the second attack technique based on the second pattern and the second reliability weight;
determining a fourth probability based on the third weighted probability and the fourth weighted probability;
determining a fifth probability of occurrence of the second attack technique in relation to the first device attribute; and
determining the third probability based on the fourth probability and the fifth probability.

18. The one or more non-transitory computer-readable media of claim 15, wherein the first probability represents a probability of occurrence of the attack technique given observing a plurality of patterns represented by the plurality of monitoring log sets, the plurality of patterns comprising the first pattern and the second pattern.

19. The one or more non-transitory computer-readable media of claim 15, wherein the responsive action comprises at least one of:
generating an alert indicating the computer network is affected by the attack technique;
isolating a device from the computer network; or
initiating a remediation process to mitigate effects of the attack technique on the device.

20. The one or more non-transitory computer-readable media of claim 15, wherein determining the first data comprises:
determining a third probability associated with an expected likelihood of occurrence of the attack technique; and
determining the first data based on the first probability, the second probability, and the third probability.
